(19) United States
(12) Patent Application Publication
(10) Pub. No.: US 2021/0260811 A1
(43) Pub. Date: Aug. 26, 2021

(54) MOLD FILLING MACHINE AND MOLD FILLING METHOD FOR A PLASTIC CONTAINER

(71) Applicant: KRONES AG, Neutraubling (DE)

(72) Inventor: Matthias WAHL, Langquaid (DE)

(21) Appl. No.: 17/253,508

(22) PCT Filed: Apr. 15, 2019
(86) PCT No.: PCT/EP2019/059663

§ 371 Date: Dec. 17, 2020

(30) Foreign Application Priority Data
Jul. 16, 2018 (DE) 10 2018 211 789.6

(51) Int. Cl. B29C 49/46; B29C 49/42; B29C 49/58

(52) U.S. Cl. CPC B29C 49/46; B29C 49/4284; B29L 2031/7158; B29C 2049/4647; B29C 2049/4664; B29C 49/58

(57) ABSTRACT

Mold filling machine for molding a plastic container from a preform in a hollow mold and for filling the plastic container with product in the hollow mold, and with a valve head comprising a filling member for filling a product into the plastic container in the hollow mold, characterized in that a reaction chamber is provided for an ignitable gas mixture in order to inject a molding fluid, in particular the product, via the valve head into the plastic container by igniting the gas mixture.

The invention relates to a mold filling machine for molding a plastic container having the features of the preamble of claim 1 and a mold filling method for a plastic container having the features of the preamble of claim 11.

Stretch blow-molding machines and methods for the production of plastic containers are known in which a plastic preform produced by injection molding is first stretched with a stretching rod inside a blow mold and then formed into the finished container by pressurization of up to 40 bar. The mechanical complexity and energy consumption of producing compressed air are disadvantageous there.

As an alternative to inflating the container with compressed air, U.S. Pat. No. 7,473,388 B2 describes a mold filling machine for PET bottles in which the preform is first heated above the glass transition temperature and then formed into the finished container within a mold by incompressible liquid, such as the product itself, and filled therewith. In order pressurize the fluid, a piston is provided which in turn is controlled by way of compressed air. However, a high pressure is necessary for the short filling times which in turn requires much effort and high energy consumption for the provision of the compressed air.

It is therefore the object of the present invention to provide a mold filling machine in which less effort and less energy consumption are required for pressurizing the liquid for forming the plastic container.

To satisfy this object, the invention provides a mold filling machine having the features of claim 1.

Advantageous embodiments are mentioned in the dependent claims.

Due to the fact that the gas mixture is ignited in the reaction chamber, it expands particularly quickly and thereby builds up a particularly high pressure in the reaction chamber. The pressure is then passed on to the molding fluid which is then injected into the finished plastic container via the filling member for forming the preform. Due to the fact that the reaction chamber can be set up in a very simple manner and without moving parts, except for the valves, the configuration effort for providing the pressure is particularly low. Furthermore, the energy of the ignitable gas mixture is efficiently converted to building up the pressure in the reaction chamber, so that energy consumption is particularly low.

The mold filling machine can be arranged in a beverage processing system. The device can be arranged downstream of a storage container for preforms, a rinser, a transport device, an injection molding machine for producing the preforms, and/or a furnace for heating the preforms. The device can be arranged upstream of a transport device, a closer, and/or a packaging machine.

The plastic containers can be provided to receive beverages, hygiene products, pastes, chemical, biological and/or pharmaceutical products. The plastic container can be a plastic bottle, a jar and/or a tube. Plastic containers can be, in particular, PET, HD-PE or PP containers or bottles, respectively. The preform can be provided to be expanded by forming in the hollow mold to form the plastic container. The preform can be produced with an injection molding process and preferably comprise a mouth portion for later closing the finished container and an adjoining hollow body that is open on one side towards the mouth portion for forming by the molding fluid into the container body.

The molding fluid can be a liquid, including those with carbon dioxide or the like dissolved therein, and is by definition an incompressible fluid in terms of its function when molding and filling the containers as opposed to a gas which is functionally defined as being a compressible fluid. The molding fluid can be the product to be filled into the container or a component of the product. However, it is also conceivable that the molding fluid is a different fluid than the product. In other words, the mold filling machine can then be configured to form the preform into the plastic container by way of the molding fluid, then to again extract the molding fluid, and then to fill the finished plastic container with the product.

The mold filling machine can comprise a transport device for transporting the plastic containers. The transport device can be a conveyor belt or a carousel. The carousel can be configured to be rotatable about a vertical axis using a drive. “Vertical” can presently mean that this is the direction that is oriented toward the center of the earth. The transport device can comprise container receptacles for receiving the plastic containers at the neck, at the container body, and/or at the container base. A transport starwheel can be arranged upstream and/or downstream of the mold filling machine.

The mold filling machine can comprise at least one treatment station for the expanding forming of the preform into a plastic container in the hollow mold and for filling the product into the plastic container in the hollow mold. The mold filling machine can comprise several treatment stations which in particular correspond to the container receptacles of the transport device. As a result, several plastic containers can be produced and filled in parallel using the mold filling machine. Each treatment station can comprise a hollow mold and a valve head. The treatment stations can be connected to a rotary distributor for distributing the molding fluid, the product, a gas, underpressure and/or overpressure. The treatment station can be configured in such a way that the preforms are introduced into the hollow mold, stretched with a stretching rod, and molded with the molding fluid to form the plastic container. The molding fluid can optionally be extracted again and the actual product filled into the plastic container.

The treatment station can comprise and/or be connected to the reaction chamber. It is also conceivable that several treatment stations each comprise and/or are connected to a reaction chamber. Alternatively, several treatment stations can also be connected to a common reaction chamber.

During molding and/or when filling the product, the valve head can be configured to correspond to the mouth of the preform or the plastic container, respectively. Furthermore, a moving unit can be provided for closing the hollow mold with the valve head in the mouth region after the preform has been introduced. Furthermore, the valve head can comprise valves, lines, nozzles, switches, and the like for introducing or discharging the molding fluid, a gas, the product, and/or various product components into the preform and/or the plastic container. In addition, the valve head can be configured to extract the molding fluid and/or a gas. The valves can be provided to regulate, release, and/or block the flow of the molding fluid, the product, and/or the gas. It is conceivable that the molding fluid, in particular the product, is injected into the plastic container via the filling member of the valve head.

A stretching rod can be provided to stretch the preform in a heated state in the hollow mold. The filling member can be at least in part integrated into the stretching rod. The stretching rod can be moved along the longitudinal axis of the preform with a longitudinal adjustment or by way of a cam control.

The filling member can be configured in such a way that, by filling the product, internal pressure can be applied to the preform or to the preform stretched with the stretching rod in such a way that the plastic container can be molded in the hollow mold. As a result, the product can be used as molding fluid for forming the plastic container and can then remain in the container. This makes the mold filling machine particularly efficient.

The reaction chamber can be configured as a cavity integrated into the valve head and/or into the treatment station or as a separate cavity. The reaction chamber can be formed by a housing that is spherical, cylindrical, or cuboid-shaped. The reaction chamber can comprise an ignition element with which the ignitable gas mixture can be ignited. The ignition element can preferably be controllable electrically. The reaction chamber can be connected to at least one supply line for the ignitable gas mixture. For example, the reaction chamber can be connected to several supply lines for introducing individual components of the ignitable gas mixture individually into the reaction chamber. This allows the mold filling machine to operate more safely, since the ignitable gas mixture is only formed inside the reaction chamber and not in the lines. The ignitable gas mixture can comprise air, hydrogen, oxygen, natural gas, and/or hydrocarbons. In other words, the ignitable gas mixture can comprise chemical components which react chemically with one another during the ignition and expand in the process. The reaction chamber can be connected via a discharge line to the valve head, preferably the filling member.

The mold filling machine can further comprise an injection cylinder with a variable dosing chamber for dispensing the mold fluid to the valve head, in particular the filling member, where the dosing chamber is directly or indirectly connected to the reaction chamber for pressure transfer of the ignited gas mixture to the mold fluid or the product, respectively. The desired amount of molding fluid or product, which is then later used to fill and/or form the plastic container, can be pre-dosed by the injection cylinder. Due to the variability of the dosing chamber, the pressure of the ignited gas mixture can be passed on to the molding fluid A variable side of the dosing chamber can be formed by movable walls of the injection cylinder and/or a surface of the molding fluid.

In addition, a movable piston or a membrane can be provided in the injection cylinder for forwarding the pressure from the reaction chamber to the dosing chamber. As a result, the pressure first acts upon the piston or the membrane and then indirectly upon the molding fluid in the dosing chamber. As a result, the reacting gases do not come into direct contact with the product. In other words, the dosing chamber can be on one side of the movable piston or the membrane, and the reaction chamber, a part of the reaction chamber, or a gas volume in communication with the reaction chamber on the other side. The injection cylinder can comprise a cylindrical inner wall with which the cylindrical piston is in sliding contact. The piston preferably comprises a cylindrical sealing surface which is in sliding contact with the cylindrical inner wall of the injection cylinder. The cylindrical sealing surface can comprise a seal, for example, made of rubber or silicone. In addition, the piston can comprise a guide rod with which the piston is guided. The membrane can be made of flexible material such as rubber or silicone. Furthermore, the membrane can be configured as a rolling membrane.

The reaction chamber can be configured separately from the injection cylinder and preferably be connected to the injection cylinder via lines in such a way that the pressure in the reaction chamber is forwarded to the injection cylinder via the lines. This ensures the mechanical decoupling of the reaction chamber from the injection cylinder, so that vibrations due to the ignition of the gas mixture are transferred less pronounced to the molding fluid.

The reaction chamber can be connected to the injection cylinder via an intermediate cylinder. As a result, the ignited gas mixture no longer comes into direct contact with the injection cylinder, which is an advantage for products that are to be processed hygienically. The intermediate cylinder can comprise a cylindrical cavity and a piston movable therein. The reaction chamber can be in communication with a first chamber of the intermediate cylinder and the injection cylinder with a second chamber of the intermediate cylinder, where the first and the second chamber are separated by the piston.

The reaction chamber can be connected to the dosing chamber via a preferably adjustable throttle. As a result, the rate of expansion of the ignited gas mixture in the injection cylinder is throttled so that the pressure on the molding fluid builds up more slowly. Consequently, the adjustable throttle can be used to control the speed at which the molding fluid is injected into the plastic container.

The reaction chamber can be connected to the dosing chamber via a preferably adjustable throttle check valve which in particular comprises a ventilation connection for expelling the gas mixture consumed. The throttle can be used to throttle the pressure build-up in the dosing chamber and thereby regulate the pressure with which the molding fluid is injected into the plastic container. In addition, the consumed gas mixture flowing back after the injection can be automatically vented via the check valve. The throttle check valve can comprise a preferably adjustable throttle and a check valve which are connected in parallel to one another. The throttle can be switched in such a way that it throttles the pressure build-up in the dosing chamber and the check valve can be switched in such a way that it enables the pressure to be reduced in the dosing chamber as quickly as possible. The ventilation connection can be connected to a gas reservoir for recycling the consumed gas mixture containing pressure.

The reaction chamber in the injection cylinder can directly adjoin the dosing chamber so that the pressure of the ignited gas mixture during operation acts directly upon a surface of the molding fluid. This makes the structure of the mold filling machine particularly simple. In other words, the injection cylinder can comprise a single chamber for the molding fluid to be injected and the ignitable gas mixture, which are only separated by the surface of the molding fluid.

The reaction chamber can be formed within the injection cylinder, and the movable piston or the membrane, respectively, can be formed as a separating element between the dosing chamber and the reaction chamber. This also ensures a simple structure of the reaction chamber and, in addition, the gas mixture is separated from the product or molding fluid, respectively, so that mixing or contamination is prevented.

The reaction chamber can be connected to a gas reservoir via a valve for recycling a pressurized consumed gas mixture. This makes it possible to reuse the compression energy in the gas after injection for subsequent plastic containers.

In addition, the invention provides a mold filling method for plastic containers according to claim 11 to satisfy the object. Advantageous embodiments are mentioned in the dependent claims.

Due to the fact that the ignitable gas mixture is ignited in the reaction chamber, a high pressure is built up particularly quickly for injecting the product or the molding fluid into the plastic container via the valve head. Since the reaction chamber does not require any mechanically movable parts or the like, apart from valves, it is particularly simple in structure as compared to the typical pressure generators and is therefore less complex. Furthermore, the conversion of energy into pressure takes place particularly efficiently due to the reaction of the ignitable gas mixture.

The mold filling method can be carried out with a mold filling machine according to one of the claims 1-10. In addition, the mold filling method can comprise individual or multiple features of the previously described mold filling machine individually or in any combination.

The molding fluid or product, respectively, can preferably be injected via the filling member.

In the mold filling method, the pressure of the ignited gas mixture can be transferred directly or indirectly to a variable dosing chamber of an injection cylinder. As a result, the molding fluid or the product, respectively, can already be pre-dosed in the dosing chamber of the injection cylinder.

The pressure can be transferred to a movable piston or a membrane of the injection cylinder which forwards the pressure to the molding fluid or product, respectively, in the dosing chamber. This reduces direct the contact of the gas mixture with the product and therefore contamination. The ignitable gas mixture can be ignited within the injection cylinder as a reaction chamber so that the pressure of the ignited gas mixture acts directly upon the surface of the molding fluid. The reaction chamber is therefore of a particularly simple structure and no mechanically movable parts are required to carry out the method. As a result, the method is particularly inexpensive.

The ignitable gas mixture can be ignited within the injection cylinder as a reaction chamber and the pressure can be transferred via the movable piston or the membrane, respectively, to the molding fluid or the product, respectively, in the dosing chamber. As a result, the reaction chamber is integrated into the injection cylinder and the mold filling method can be carried out particularly easily. In addition, the product is separated from the gas mixture by the movable piston or membrane, respectively, so that contamination is prevented.

Alternatively, a gas or gas mixture that is heated and expands accordingly can be used instead of the ignitable gas. In order to achieve a correspondingly high expansion of the gas, it is advantageous to ensure that there is a high temperature difference between the gas when it is introduced into the reaction chamber (initial temperature) and when the reaction is complete (final temperature). This results in the direct dependence of the absolute expansion of gases in dependence of the coefficient of thermal expansion (which is very similar for most gases) and the temperature. For example, (liquid) nitrogen having a temperature well below room temperature can be used. If it is heated to room temperature it expands in an explosive manner. The effect can be increased if the reaction chamber is heated and therefore the temperature difference between the initial temperature and the final temperature is further increased. In the above-mentioned sense, a gas or gas mixture is also understood to mean a product which has a gaseous physical state only at the point in time when the final temperature is present. The physical state at the initial temperature can be quite different (e.g. liquid, solid). Solid initial material can be, for example, dry ice.

Further features and advantages of the invention shall be explained in more detail below with reference to the embodiments illustrated in the figures, where

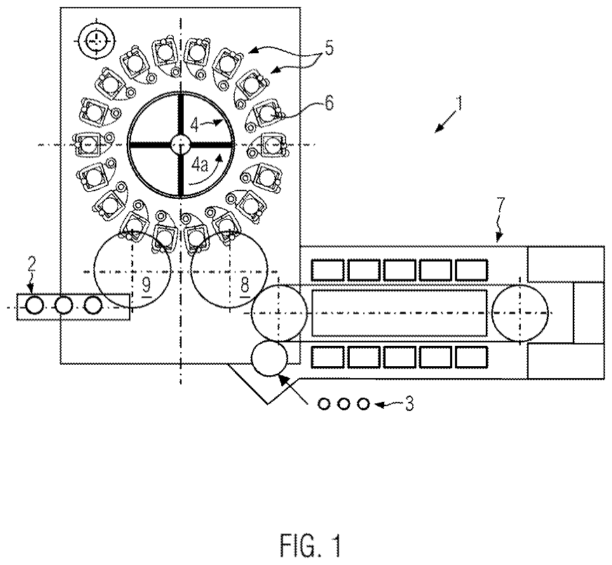

FIG. 1 shows an embodiment of a mold filling machine in an overview from above;

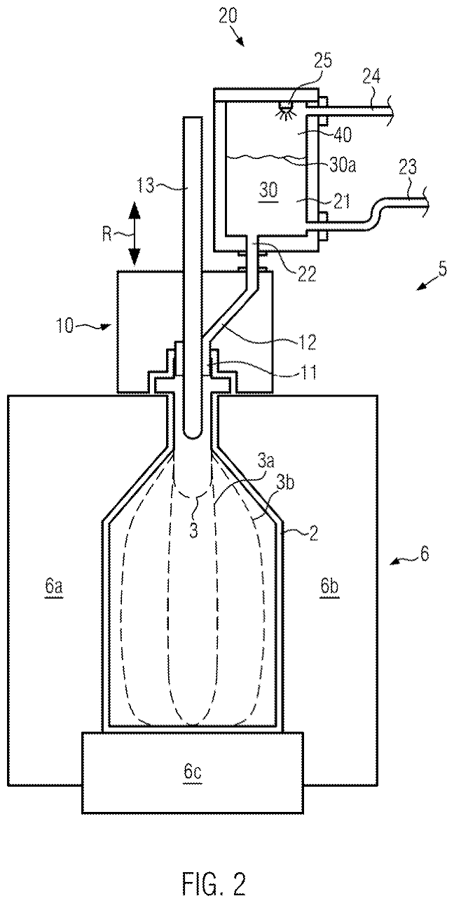

FIG. 2 shows an embodiment of a treatment station of the mold filling machine shown in FIG. 1 in a lateral view;

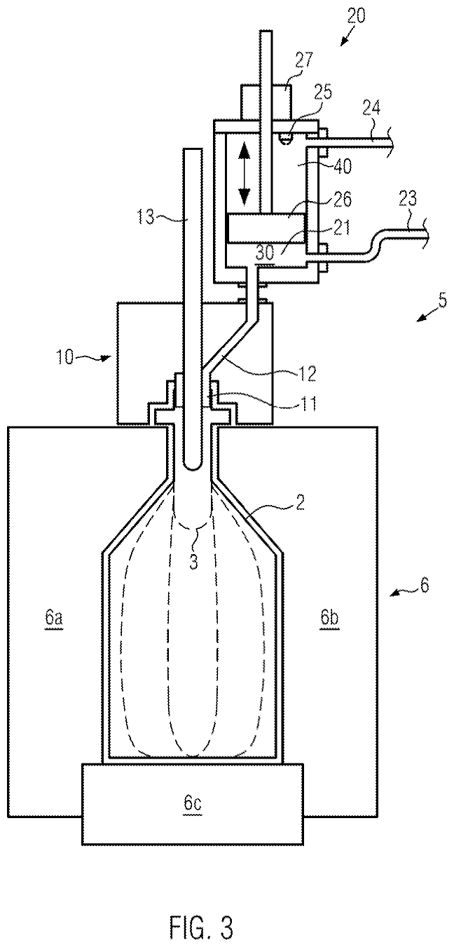

FIG. 3 shows an embodiment of the treatment station as an alternative to FIG. 2 in a lateral view; and

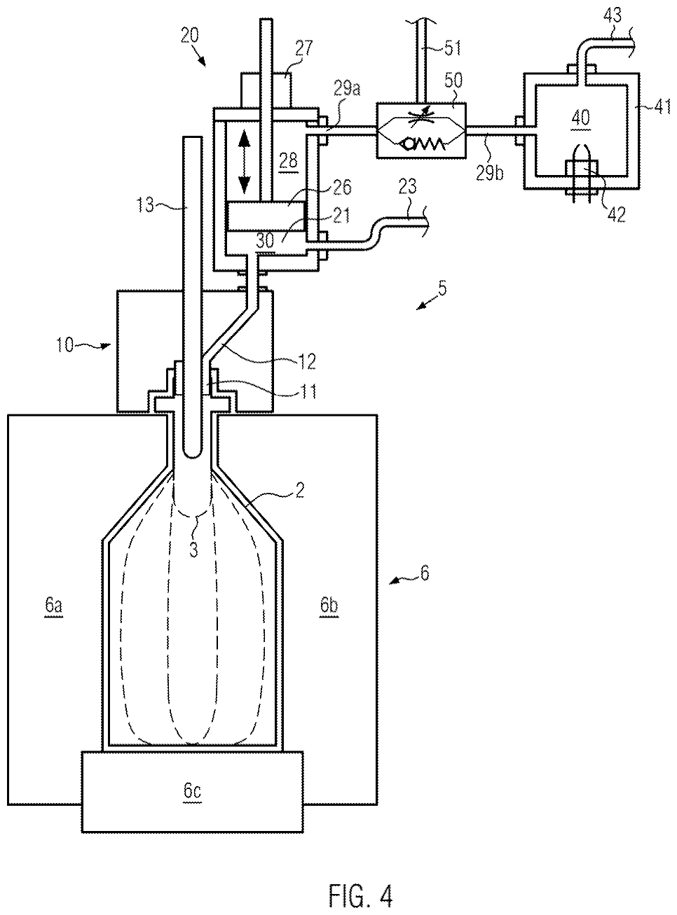

FIG. 4 shows a further embodiment of the treatment station as an alternative to FIG. 2 or 3 in a lateral view.

FIG. 1 illustrates an embodiment of a mold filling machine 1 with an upstream furnace 7 in a top view. Preforms 3 can be seen which first pass through furnace 7 and are there heated to such an extent that they can be formed into the desired container shape with downstream mold filling machine 1. The heated preforms are subsequently transferred with infeed starwheel 8 to treatment stations 5, which shall be described in more detail below with reference to FIGS. 2 [sic]. When carousel 4 rotates in direction 4a, preforms 3 are stretched in treatment stations 5, formed into the desired container shape, and filled with the molding fluid or the product, respectively. Preforms 3 or molded containers 2, respectively, always remain in hollow molds 6. After filling, containers 2 are supplied to further treatment steps via discharge starwheel 9. For example, a capper with which the plastic containers 2 are closed can be disposed downstream of or associated with mold filling machine 1. Plastic containers 2 are presently PET containers, but can be made of any other suitable plastic material.

FIG. 2 shows a lateral sectional view of a treatment station 5 of mold filling machine 1 shown in FIG. 1. It can be seen that preform 3 has already been introduced into hollow mold 6. In the region of the mouth, preform 3 has a collar and a thread, not presently shown in greater detail, which is later used to screw on a closure. Individual mold parts 6a-6c of hollow mold 6 can be moved apart and together via a multi-part mold carrier (presently not shown) in order to release the fully molded container after filling. It is also conceivable that preform 3 is either inserted into the opening of hollow mold 6 from above or is introduced into hollow mold 6 by opening and closing mold parts 6a-6c.

Valve head 10 can also be seen with filling member 11 for filling molding fluid 30 and with stretching rod 13 for stretching preform 3 during the forming process. Furthermore, valve head 10 can be moved in direction R by a moving unit or cam control (presently not shown) for lowering it onto hollow mold 6 and thereby close it off from the environment during forming and filling. It is conceivable that valve head 10 comprises sealing elements for preform 3 and/or for hollow mold 6.

Molding fluid 30 is presently directly the product to be filled, for example, mineral water or a liquid suitable for forming, and is provided via supply line 12 at a suitable pressure and is injected via filling member 11 into pre-stretched preform 3a. Pre-stretched preform 3a is pressed particularly quickly against the shaping inner surfaces of hollow mold 6 by the molding fluid and is thus molded into the finished plastic container. At the same time, the molding fluid absorbs the heat from preform 3 so that the container acquires its dimensional stability as quickly as possible after the forming process. After molding, molding fluid 30 remains as a product in finished plastic container 2. However, it is also conceivable that the molding fluid is only used for forming and again extracted before the actual product is filled. This is advantageous, for example, with pressure-sensitive products.

Intermediate states 3a, 3b can also be seen during the forming of preform 3 into finished plastic container 2 by molding fluid 30.

It can also be seen that filling member 11 is connected to injection cylinder 20 via line 12, 22. Molding fluid 30 is already pre-dosed in dosing chamber 21 of injection cylinder 20. Line 2, via which the liquid is supplied, for example, from a storage tank or a rotary distributor, is provided to supply molding fluid 30. Formed above surface 30a of molding fluid 30 within injection cylinder 20 is reaction chamber 40 into which an ignitable gas mixture is introduced via supply line 24. The ignitable gas mixture is, for example, hydrogen and oxygen or any other ignitable gas mixture. In other words, disposed within injection cylinder 20 is a chamber which is filled in one part 21 with product 30 and in second part with the ignitable gas mixture.

In order to apply the necessary pressure for forming preform 3 into plastic container 2, the ignitable gas mixture in reaction chamber is ignited electronically by way of ignition element 25. This causes the gas mixture to react and expand abruptly. The resulting pressure is released directly onto surface 30a of molding fluid 30a so that molding fluid 30 is injected into preform 3 via line 22, 12 and filling member 11 so that preform 3 expands across states 3a, 3b into finished plastic container 2. Forming can be supported by stretching rod 13, as described above. Hollow mold 6 is subsequently opened and the completely filled plastic container is dispensed.

For example, other ignitable gas mixtures which are introduced into reaction chamber 40 via a line 24 or various lines can also be used for the invention.

An embodiment of treatment station 5 as an alternative to FIG. 2 can be seen in FIG. 3 in a lateral view. It differs from FIG. 2 essentially in that movable piston 26 is arranged within injection cylinder 20. The movable piston forms a separating element between reaction chamber 40 and dosing chamber 21. Furthermore, piston 26 can be moved by way of a rod and moving unit 27 for dosing molding fluid 30 or the product using a control unit, presently not shown.

Piston 26 is first moved upwardly so that product 30 is suctioned into dosing chamber 21 via line 23. Furthermore, an ignitable gas mixture is introduced into reaction chamber 40 via line 24. As described above, the ignitable gas mixture is then ignited electronically by ignition element 25 and thereby expands abruptly. Consequently, a high pressure prevails in reaction chamber 40 and presses piston 26 downwardly in FIG. 3 with a corresponding force so that product 30 in dosing chamber 21 is injected via line 12 and filling member 11 into preform 3. The latter expands accordingly and nestles against the inner walls of hollow mold 6. Plastic container 2 is then completely filled with product 30 and can be removed from hollow mold 6, as described above.

Due to the fact that the piston is formed between reaction chamber 40 and dosing chamber 21, the ignitable gas mixture or its reaction products, respectively, does not come into direct contact with the molding fluid and contamination is consequently prevented.

FIG. 4 shows a further embodiment of treatment station 5 as an alternative to FIG. 2 or 3 in a lateral view. It differs from the embodiment in FIG. 2 essentially in that reaction chamber 40 is arranged separately from injection piston 20.

It can be seen that separate reaction chamber 40 is formed with housing 41 and ignition element 42. The ignitable gas mixture can be supplied via lines 43. As a result of the subsequent ignition of the gas mixture with ignition element 42, a high pressure builds up in reaction chamber 40 and is released into upper chamber 28 of injection cylinder 20 via line 29b, throttle check valve 50, and line 29a. Adjustable throttle check valve 50 serves to throttle the pressure build-up in such a way that the motion of piston 26 is performed in a selective or more slowly manner. Due to the pressure in chamber 28 being regulated in this manner, piston 26 is pressed onto molding fluid 30 in dosing chamber 21 so that the molding fluid is injected via line 12 and filling member 11 into preform 3 or plastic container 2. As a result, plastic container 2 is molded in hollow mold 6 and filled. Filled plastic container 2 is then ejected from hollow mold 6.

For next plastic container 2 to be filled, piston 26 is then moved upwardly again with moving unit 27 in FIG. 4 so that the consumed gas mixture in chamber 28 is injected back via line 29a into throttle check valve 50. The check valve installed there opens and the consumed gas is passed to ventilation connection 51 and can possibly be recycled. It is also conceivable that it is stored in a compressed air reservoir for pressurizing the ignitable gas mixture in reaction chamber 40 before ignition.

Furthermore, it is conceivable that reaction chamber 40 is connected to injection cylinder 20 via an intermediate cylinder. As a result, the ignited gas mixture does not reach chamber 28, whereby even the slightest contamination of product 30 is prevented for a particularly hygienic treatment.

In a modification of the embodiments in FIGS. 3 and 4, a membrane, preferably a rolling membrane, can also be used instead of piston 26. As a result, injection cylinder 20 is of an even simpler structure.

The Mold filling method describe above can be carried out according to one of claims 1-15 with a mold filling machine described in FIGS. 1-4.

It is understood that the features mentioned in the embodiments described above are not restricted to these specific combinations and are also possible in any other random combination.

1. Mold filling machine for molding a plastic container from a preform in a hollow mold and for filling said plastic container in said hollow mold with product and
with a valve head comprising a filling member for filling a product into said plastic container in said hollow mold,
wherein,
a reaction chamber is provided for an ignitable gas mixture in order to inject a molding fluid, in particular said product, via said valve head into said plastic container by igniting said gas mixture.

2. The mold filling machine according to claim 1, where said mold filling machine further comprises an injection cylinder with a variable dosing chamber for dispensing said mold fluid to said valve head, and where said dosing chamber is directly or indirectly connected to said reaction chamber for pressure transfer of a said ignited gas mixture to said mold fluid.

3. The mold filling machine according to claim 2, where a movable piston or a membrane is provided in said injection cylinder for forwarding the pressure from said reaction chamber to said dosing chamber.

4. The mold filling machine according to claim 2, where said reaction chamber is formed separately from said injection cylinder and is preferably connected via lines to said injection cylinder such that the pressure in said reaction chamber is transferred to said injection cylinder via said lines.

5. The mold filling machine according to claim 2, where said reaction chamber is connected to said injection cylinder via an intermediate cylinder.

6. The mold filling machine according to claim 2, where said reaction chamber is connected to said dosing chamber via a preferably adjustable throttle.

7. The mold filling machine according to claim 2, where said reaction chamber is connected to said dosing chamber via a preferably adjustable throttle check valve which in particular comprises a ventilation connection for expelling the gas mixture consumed.

8. The mold filling machine according to claim 2, where said reaction chamber in said injection cylinder directly adjoins said dosing chamber so that a pressure of a ignited gas mixture during operation acts directly upon a surface of said molding fluid.

9. The mold filling machine according to claim 3, where said reaction chamber is formed within said injection cylinder and said movable piston or said membrane is formed as a separating element between said dosing chamber and said reaction chamber.

10. The mold filling machine according to claim 1, where said reaction chamber is connected to a gas reservoir via a valve for recycling a pressurized consumed gas mixture.

11. Mold filling method for plastic containers,
where a preform is formed in a hollow mold into a plastic container by filling it with a molding fluid, in particular product,
an ignitable gas mixture is ignited in a reaction chamber and said molding fluid is thereby injected via a valve head into said plastic container.

12. The mold filling method according to claim 11, where the pressure of the ignited gas mixture is transferred directly or indirectly to a variable dosing chamber of an injection cylinder.

13. The mold filling method according to claim 12, where the pressure is transferred to a movable piston or a membrane of said injection cylinder which forwards the pressure to said molding fluid in said dosing chamber.

14. The mold filling method according to claim 12, where the ignitable gas mixture is ignited within said injection cylinder as a reaction chamber so that the pressure of the ignited gas mixture acts directly upon the surface of said molding fluid.

15. The mold filling method according to claim 13, where the ignitable gas mixture within said injection cylinder as a reaction chamber is ignited and the pressure is forwarded via said movable piston or said membrane, respectively, to said molding fluid in said dosing chamber.
